(19) United States
(12) Patent Application Publication
(10) Pub. No.: US 2006/0084462 A1
(43) Pub. Date: Apr. 20, 2006

(54) Presenting an information item on a mobile device

(76) Inventor: Krishna Prasad Panje, Bangalore (IN)

Correspondence Address: PHILIPS INTELLECTUAL PROPERTY & STANDARDS, P.O. BOX 3001, BRIARCLIFF MANOR, NY, 10510, US

(21) Appl. No.: 10/533,923

(22) PCT Filed: Oct. 8, 2003
(86) PCT No.: PCT/IB03/04487

§ 371 Date: May 3, 2005

(30) Foreign Application Priority Data
Nov. 6, 2002 (EP) 02079631.4

(51) Int. Cl. H04M 1/00

(52) U.S. Cl. 455/550.1

(57) ABSTRACT

This invention relates to a method of and a mobile device (10) for presenting an information item. Said mobile device can be a personal digital assistant, a palm top, a cell phone or a mobile phone. Said method including the steps of: retrieving an identification of at least one of user gear and apparel; determining a mode reflecting at least one attribute of identified gear and apparel and optionally sending the mode with an identification of said mobile device to a service provider; determining and presenting (13, 15) the information item dependent on said mode. Said method further includes the steps of: receiving a first message from a caller sent to said mobile device; determining a second message dependent on said mode, when said first message is received; and sending the second message to the caller as a response to said first message. Said method's step of determining a second message includes the steps of: sending the mode with an identification of said mobile device to a service provider; and determining the second message based on the received mode and the identification of said mobile device on the service provider. Said method further comprises the step of modifying at least one attribute of gear and apparel. This enables that an unpleasant or a dangerous situation of the mobile device emitting irritating sound or coming up with an intense, flashing coloured display is solved since said mode only presents what is convenient for the user. Further the mobile device or the service provider can automatically without user interaction respond to a call.

This invention relates to method of presenting an information item on a mobile device.

The present invention also relates to a computer system for performing the method.

The present invention further relates to a computer program product for performing the method.

Additionally, the present invention relates to a mobile device for presenting an information item.

U.S. Pat. No. 6,249,222 discloses an apparatus for providing a colour-based alerting signal to a user to alert him when a predetermined event occurs. The alerting apparatus can be a ring, a computer, a strap, a wristwatch or an article of clothes with an incorporated colour based device.

However, it is a problem in mobile devices, such as PDAs, mobile phones, etc that information provided automatically from said mobile devices can bring the user in an awkward or in a dangerous situation. E.g. when the user is driving on the highway it can be disturbing or even dangerous to be alerted messages by means of music or sound since such messages may divert one's attention away from a potential dangerous situation. It is a further problem—also when using mobile devices—that it may be unpleasant for a user during a meeting or during a presentation on an overhead that his mobile device emits irritating sounds or comes up with an intense, flashing coloured display thereby drawing attention to the mobile device's information.

For further enhancement of safety, it is convenient to automatically inform callers what the owner of mobile device is actually doing, when called.

Said problems are solved by said method, when the method comprises the steps of:
retrieving an identification of at least one of user gear and apparel;
determining a mode reflecting at least one attribute of identified gear and apparel and optionally sending the mode with an identification of said mobile device to a service provider; and
determining and presenting the information item dependent on said mode.

Hereby—in the first step, IDs of gear and apparel—may provide the mobile device with information on the user's context or environment, such as the user's clothes, glasses, shoes, sports gear or music gear. This is possible since the gear and apparel each may have an identification code, such as a printed barcode, a printed pattern, a smart card, a magnet stripe, a transponder, a code tag, etc. One or more attributes may be comprised in said identification code. Said identification code—with corresponding attributes—may be read by the mobile device in this first step.

In the second step, one or more attributes—of identified gear and apparel—combined may define a mode for a presentation style subsequently used in the third step.

Hereby the mobile device, e.g. a PDA device, a cell phone etc. may in the presentation—in the third step—use a particular colour to achieve that the mobile device's display displays in a colour similar to that of the clothes of the user's dress.

Optionally, the mode with an identification of said mobile device is sent to the service provider, which then may catch any incoming call and avoid that these—dependent on the mode—arrive to said mobile device. Further, the mode—on the service provider—may forward calls to another mobile device or respond via a voice mail, a voicemail greeting, etc.

The presentation—still in the third step—may also be a non-presentation, i.e. the mobile device may be switched into a mode of non-ringing or non-displaying mode. Hereby, the user can perform a safe trip in the traffic, since he is not disturbed by incoming calls.

In other words, the problem—or situation—of information being provided automatically from mobile devices, PDA's, mobile phones can bring the user in an unpleasant or in a dangerous situation—is solved by said three steps since said three steps can avoid said situation.

Additionally, the unpleasant situation that the mobile device emits irritating sound or comes up with an intense, flashing coloured display is further avoided. It is avoided since said three steps—in another mode, in another presentation style—can prohibit such behaviour.

Correspondingly, a fashion conscious user of the mobile device may—in another mode (dependent on his dress ID)—experiences that his mobile device's display displays in a colour similar to that of his clothes.

In an embodiment of the invention, said method further comprises the steps of:
receiving a first message from a caller sent to said mobile device;
determining a second message dependent on said mode when said first message is received; and
sending the second message to the caller as a response to said first message.

Generally, in the above fourth to sixth step, one or more attributes in combination may define a mode used for responding to a caller without user interaction.

In the fourth step, said first message is sent from another mobile device's caller by means or through the service provider to the receiving mobile device.

In the fifth step, as a response to said first message, said second message is determined dependent on the current mode of the receiving mobile device.

In the sixth step, the receiving mobile device may—apart from being in a specific presentation mode—in particular provide the effect that a voicemail greeting message is automatically returned to the caller, e.g. the voicemail greeting message may be a sound of traffic noise, making the caller aware of that the user is driving at the moment. Hereby, the user (of the receiving mobile device) can both perform a safe trip in the traffic and at the same time he can indirectly inform the caller—without his interaction—what he is actually doing, i.e. driving.

Hereby, safety is enhanced since callers can automatically—without the called person's interaction—be informed what the called person is doing. This can be lifesaving to know what the called person is doing—and where located—in a subsequent emergency or accident situation.

In a further embodiment of the invention, the step of determining a second message comprises the steps of:
sending the mode with an identification of said mobile device to a service provider; and
determining the second message based on the received mode.

Hereby,—in these two steps—said service provider may determine said second message when the service provider is aware of the mode and identification of said mobile device.

Said problems are further solved by said mobile device, when the mobile device comprises:
at least one identification reader for retrieving an identification of at least one of user gear and apparel;
means for determining a mode reflecting at least one attribute of identified gear and apparel and means for optionally sending the mode with an identification of said mobile device to a service provider; and
means for determining and presenting the information item dependent on said mode.

In an embodiment of the invention, the mobile device further comprises:
means for receiving a first message from a caller;
means for determining a second message dependent on said mode, when said first message is received; and
means for sending the second message to the caller as a response to said first message.

In a further embodiment of the invention, the means for determining a second message comprises:
means for sending the mode with an identification of said mobile device to a service provider, where said service provider then determines then the second message.

In still a further preferred embodiment of the invention, said mobile device further comprises:
means for modifying at least one attribute of gear and apparel.

The mobile device gives the same advantages for the same reasons as described previously in relation to the method.

The invention will be explained more fully below in connection with preferred embodiments and with reference to the drawings, in which:

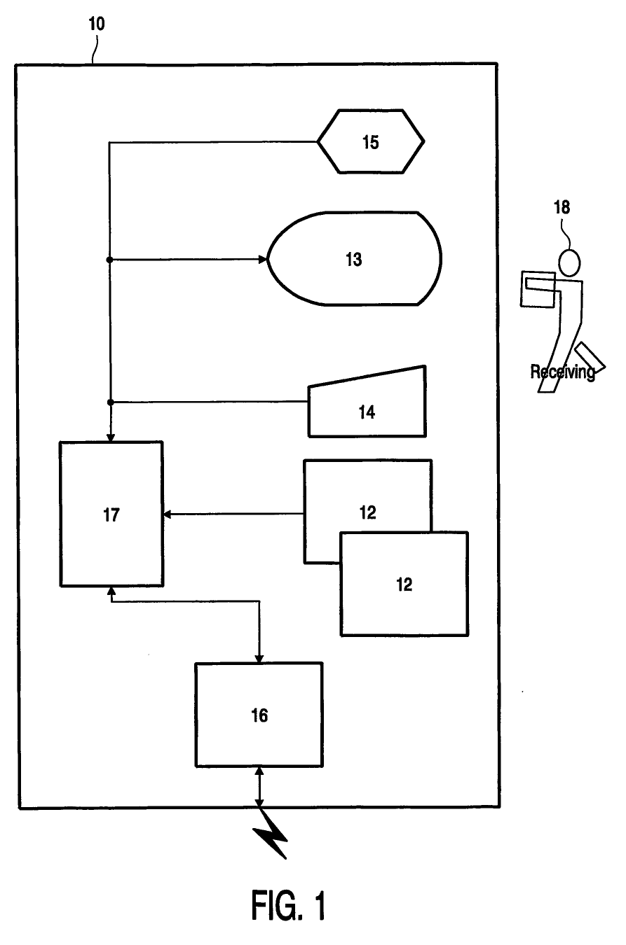

FIG. 1 shows a first embodiment of a mobile device;

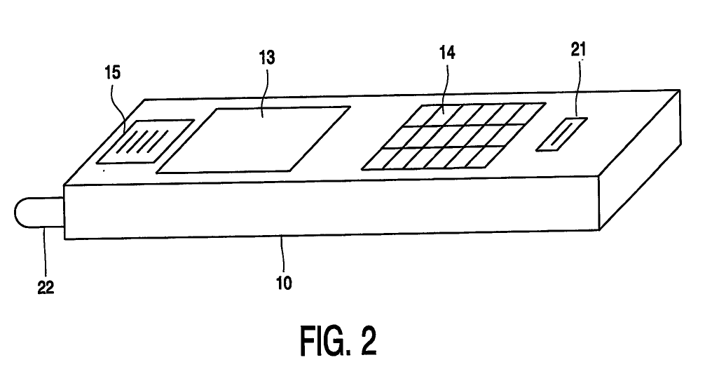

FIG. 2 shows a second embodiment of the mobile device; and

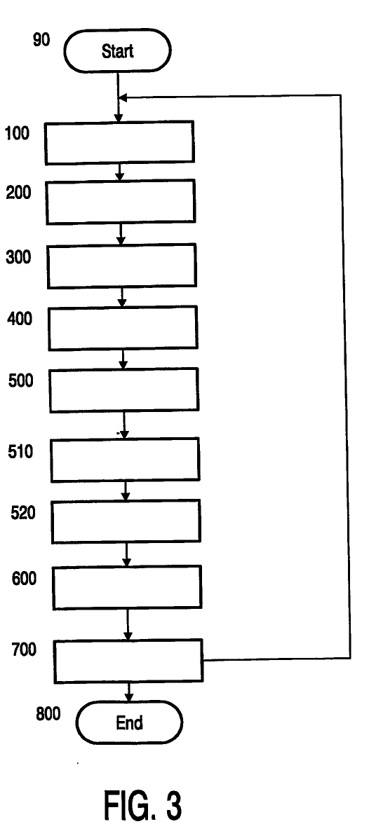

FIG. 3 shows a method of presenting an information item on a mobile device.

Throughout the drawings, the same reference numerals indicate similar or corresponding features, functions, etc.

FIG. 1 shows a mobile device. Said mobile device will be described by means of its features. The mobile device is shown by reference numeral 10. A user—as indicated by reference numeral 18—may obtain information content from the mobile device's display, reference numeral 13, and/or from a loudspeaker, reference numeral 15, each positioned on the front. Said information content may be displayed on the display and said information content when it comprises sounds or music may optionally or additionally be emitted by means of the loudspeaker 15 or on a like device such as a piezo. The mobile device may be operated in conjunction with other mobile devices, which may thereby basically provide the user with sound, textual and image information. The use of the mobile device in conjunction with other units will be discussed in FIG. 3. Integrated in the mobile device may be one or more different identification readers, reference numeral 12 may be positioned or embedded in the mobile device.

That or those identification reader(s) may then be used to inform the mobile device in which environment it is being used. The identification reader may be any sensor capable of receiving or reading a signal as known in the prior art used to identify items. Items according to the present invention may be the user's apparel, such as his clothes, shoes, glasses, outfit and the user's gear, such as sports gear, other kinds of gear, e.g. music gear, etc. Said item may be tagged or given an identification (code) by means of a printed barcode, printed pattern, a smart card, a magnet stripe, a transponder, a code tag, a RF tag, etc. Correspondingly, the identification reader may be a barcode reader, a smart card reader, a magnet stripe reader, a transponder reader, a tag reader, a pattern reader, such as an optical reader, etc.

It is therefore possible to have an intelligent system comprised of the mobile device with identification readers and gear/apparel with attached or embedded IDs, such as said barcode, printed pattern, smart card, magnet stripe, a transponder, tag, etc. The most intelligent of said IDs may have an integrated micro-controller with a built in power source, such as a magnetic reception of power, a battery, a capacitor or a solar—power source, memory with amendable attribute(s) and with self-contained amendable program(s) embedded. Now, the user may re-program/run for example a Java applet on IDs using his mobile device (PDA, phone, etc).

This means that the mobile device may access, i.e. read or write, identifications of said items (apparel, gear, etc.) either by close contact to the ID's of the items or by means of wireless communication.

By means of said identification reader(s) of reference numeral 12, the mobile device's environment with respect to the user apparel and/or gear may be determined. When the environment of the mobile device(s) is known, information content—reflecting said environment—may be determined for a subsequent presentation on the mobile device. This will also be discussed in a method in FIG. 3.

Conversely, by means of identification writers (not shown) integrated in the mobile device, the mobile device may program or download one or more attributes to said IDs.

The user may respond to previously mentioned information content given by means of an input device as shown by reference numeral 14. The input device may be a keyboard, some other pushbutton and/or fields sensitive to touch on said display. The input device may further be a button and/or an arrangement of buttons, a pointing device, such as a mouse, a trackball, a touch pad, a digital pen, or the like. Additionally, said input device may comprise a microphone for reception of voice and speech commands controlling the functionality of said mobile device, e.g. a mode, a presentation format, message or response given reflecting a determined mode, gear of the user, apparel of the user, etc.

Said information content may—by means of the processor—be displayed and/or played back or redirected to other mobile devices by means of a service provider. The mobile device may receive said information by means of communication device, reference numeral 16 connected to a processor, reference numeral 17. The communication device may receive or send information by means of a network, e.g. a local area network (LAN), a wide area network (WAN), or any combination thereof, e.g. the Internet, an intranet, an extranet. The network may-comprise wired and wire-less communication links, e.g. a mobile communications network. Said network may be a general solution known from the prior art, or it may be dedicated to an optimized communication between mobile devices and the service provider.

Said processor is arranged to receive inputs from the display, if it has touch-sensitive fields on its front, the input device, signal from said identification reader(s) and the communication device. The processor is further arranged to generate display data to the display, sound or music data to the speaker, and other data in a response to the communication device.

FIG. 2 shows a preferred embodiment of the invention, which may contain the mobile device. Shown is a mobile telephone as one embodiment of the mobile device—still reference numeral 10—having display means, reference numeral 13, a keypad, reference numeral 14 as input means, an antenna, reference numeral 22, connected to previously mentioned communication device, a microphone reference numeral 21 as another possible input means, and a speaker as reference numeral 15. The method—as discussed in the next figure—according to the present invention may be executed on said mobile device just requiring very little additional hardware and/or additional computational effort. As alternatives to said mobile telephone may be a personal digital assistant, a palm top or a cell phone.

FIG. 3 shows a method of presenting an information item on a mobile device.

In step 90, the method in accordance with a preferred embodiment of the invention is started. Variables, flags, buffers, etc., keeping track of identified gear or apparel, presented content, messages, callers, etc, corresponding to the status of the mobile device corresponding to the status of the same mobile device on the service provider are set to default values. When the method is started a second time, only corrupted variables, flags, buffers, etc, are reset to default values.

In step 100, an identification of at least one of user gear and apparel may be retrieved by means of the mobile device. In order to make said mobile device aware of its surrounding environment, i.e. the user's apparel, such as his clothes, shoes, glasses, outfit and the user's gear, such as sports gear, other kinds of gear, e.g. music gear, etc; the mobile device may in this step identify it or them.

In other words, the user's apparel and the user's gear has to be identified, therefore they can be tagged or given an identification code by means of a printed barcode, printed pattern, a smart card, a magnet stripe, a transponder, a code tag, etc. Correspondingly, the identification of at least one of user gear and apparel may be retrieved by means of the previously mentioned identification reader, such as a barcode reader, a smart card reader, a magnet stripe reader, a transponder reader, a code tag reader, a pattern reader, an optical reader, etc. as shown by means of reference numeral 12 in FIG. 1.

Said identification code may be conducted by means of a printed bar code, etc, which may be positioned on, in or embedded in the gear and apparel, where appropriate for reading. Each of these (taggings or identification codes) may have it's own unique identification with one or more attributes. The attributes may be modified; this will be discussed in step 700.

In step 200, a mode of the mobile device may be determined. Said mode may reflect at least one of the attributes of the identified gear and apparel. Further—optionally—said mode with an identification of said mobile device can be sent to a service provider.

In the following, examples give basis—in one or more attributes—to determine a mode subsequently used to define how—in the next step—an information item may be presented.

### EXAMPLE 1

Consider a user riding a motorcycle, wearing a riding jacket (as one exemplary piece of apparel) and removing the riding jacket after he finished his ride. It would be convenient—in a preferred embodiment of the invention—if the mobile device worn, e.g. a mobile phone, could stay switched into a mode of non-ringing mode during the ride—and during the ride time also ensure that this particular mode will cause that a voicemail greeting message (automatically returned to a caller) to be a sound of a motorcycle's engine, makhig the caller aware of called person's situation. Hereby, the user can both perform a safe motorcycle-ride—since he is not disturbed by incoming calls—and at the same time inform the caller what he is actually doing. The latter may be helpful if—later—contact is lost to the user of said mobile phone. Said attributes—determining the mode of “non-ringing during the ride and response via a voicemail with a sound of a motorcycle's engine”—may be attributes like 123 on an identification (readable of said identification reader) on the riding jacket may define that 1=black, i.e. the colour of the jacket, 2=riding jacket and 3=switch to biker voicemail greetings.

Please note that in this example, voicemails are stored on the mobile device, so—the service provider does not need directly to respond to calls (to the mobile device) since this particular mode forces the mobile device—by itself—to automatically to respond to incoming calls.

In other words, the attribute(s) belonging to one or more of identified gear and apparel may—when mixed and combined—determine a mode used for a subsequent presentation of information—and the response given—on/from the mobile device in the next steps.

As discussed it is an option to send said mode with the identification of the mobile device to the service provider. With said mode (and identification) the service provider will know how to handle and eventually how to respond to in coming calls. Example 2 shows where it can be appropriate to take advantage of the option: after reading the RF tag on the apparel indicating Monday schedule, i.e. team meeting from 10 to 12 am, where the user does not want to be disturbed from 11 to 12 (from calls to his mobile device)—the mobile device may set to be in a corresponding mode of “unconditional call forwarding to my secretary during the meeting”, the mobile device may—or service provider may—register the unconditional call forwarding to the secretary's telephone number between 11 and 12 am. At 11 am the mobile device may make a request to service provider, e.g. the network operator, which is the mode of “register unconditional call forwarding to the secretary's number until 12 am the same day”. After 12 am the mobile device may make a new request to service provider telling it is again in another mode for reception of calls. In other words, either the mobile device or the service provider may know when to switch (between) mode(s) on the mobile device.

In step 300, the information item may be determined and presented. Essentially, the information item may be determined dependent on said mode before a subsequent presentation is performed on the mobile device. The presentation may take place by means of the display and/ or the speaker as discussed in FIG. 1.

As another example, assume that a red shirt—as apparel—has the attributes 212, which may describe, 2=red, 1=weekend shirt and 2=switch to a primarily reddish display, when possible. The user may first program his mobile device for a particular behaviour for a particular dress, i.e. using and eventually programming said dress' attributes. The barcode, smartcard, or magnetstripe, etc. on the weekend shirt may correspondingly comprise said attributes. In other words, said attributes—when read by the identification reader, e.g. the barcode reader or the smart card reader, etc.—define the behavior of the presentation of said information item, i.e. the mode (of presentation) for the mobile device.

The user may provide actions to be taken for each particular attribute (belonging to a set of attributes for a given apparel or gear) on his mobile device. He may program them directly on the mobile phone or alternatively use an application on a PC and then download them to the mobile device—in both cases prior to use and prior to this particular step.

Said information item may comprise combinations of presentable items, such as plain text, pictures, frames, video, word-processor data, spread-sheet data, calendar or almanac information, schedule information, text or picture messages, voice mail, video mail, e-mail, SMS, etc.

Accordingly the determined mode determines how said presentable items are to be displayed, e.g. how buttons are backlit, backlight of display, colour of characters, text, frames, level and/or type of sound, music, texture, volume and/or kind of ring tone, switching on or of, vibration on or of, etc. In the example of attributes such as “the red shirt”, “weekend shirt” and “switch to a primarily reddish display”, the mobile device may—e.g.—provide a red backlight of the display and/or red characters on a different coloured background, thereby using a mode reflecting said attributes.

Hereby, it is an advantage of the invention that a fashion-conscious user may achieve that his mobile device's display displays in a colour similar that of his clothes (apparel).

In step 400, a first message may be received on the mobile device. Said first message—may have been transmitted from another mobile device's caller by means of or through the service provider. The reception of the caller's call or incoming message may take place without notification to the user (i.e. the called person) of the mobile device, if the actual mode of the mobile device is defined to do so. Correspondingly—which will be discussed in the following the notification as a response to the call and the kind of notification to the caller, i.e. the person sending said first message, may take place and may be determined dependent on the previously determined mode as previously discussed in step 200.

In step 500, a second message may be determined. The second message may also be dependent on said mode as discussed in step 200. The second message may typically be determined as a response to said first message. In a preferred embodiment of the invention, the second message is to be determined on the service provider. This is discussed in the following two steps, where said step 500 constitutes a generalisation of steps 510 and 520.

In step 510, the mode with an identification of said mobile device may be sent to a service provider. In order to identify the mobile device transmitting to the service provider, the mobile device is identified by said identification, i.e. a telephone number or a net address. Additionally, the previously discussed mode is sent to the service provider. Hereby, the service provider knows the current mode and from which particular mobile device it belongs.

In step 520, the second message based on the received mode and the identification of said mobile device may be determined on the service provider. With knowledge of the current mode and from which it belongs (e.g. the telephone number and/or the net address), the service provider may determine said second message especially dependent on the received mode. With regard to a variant of example 1—with the service provider being involved—, i.e. the user is still riding the motorcycle wearing his riding jacket having the attribute 3=switch to biker voicemail greetings (as a part of the attributes defining the mode), said second message may consequently comprise “a voicemail with a sound voicemail with a sound of a motorcycle's engine”. It is worth noting that—in steps 200 and 300—the same mode determined that the mobile device should not “be ringing during the ride”.

The meaning of any mode (with belonging attribute( )s) may be determined on the service provider. Assume that the user has five voicemail greetings stored on the service provider, with the third one being the biker voicemail. Thus, in this implementation, an attribute having the value “2” may mean “riding jacket”, in order to switch to “voicemail mode”, the attribute may be modified to have the new value “3” thus selecting the third voicemail greeting from the service provider.

As compared to step 200, where the mobile device—by itself (by a mode) defined a response to a call—here, the service provider may generate more complex responses to a call, for example informing the caller that he now—in vain—had tried a number of times to call, this may be a part of said second message. Further—in the steps 500 through 600—even though the mobile device is in a mode where it is un-powered or it's owner deliberately switched it of—it is an advantage of the invention that the service provider can still respond in an intelligent way to a call.

In step 600, the second message may be sent to the caller as a response to said first message. Hereby—in a continuation of the example 1—the caller will receive said voicemail with a sound of a motorcycle's engine from the service provider. Hereby, the caller is notified that the user of the mobile device in example 1 is for the moment riding his bike and does not want to be disturbed, and still wanting to inform any caller what he is doing, i.e. he is riding his motorcycle.

Generally, the attribute(s) belonging to one or more of identified gear and apparel—defined in the printed barcode, printed pattern, the smart card, the magnet stripe, the transponder, the code tag, etc as a part of gear and apparel—may in the steps 400 through 600—when mixed and combined—determine the response given from the mobile device without user interaction.

It is hereby an advantage of the invention that the user can both perform a safe motorcycle-ride—since he is not disturbed by incoming calls—and at the same time he can automatically inform anybody who calls him what he is actually doing.

Generally, it is hereby an advantage of the invention that the user can both perform any undisturbed activity and at the same time automatically be informing anybody who calls him what he is actually doing, if desirable.

In step 700, at least one attribute of gear and apparel may be modified. It may be the case that the user desires to have another presentation, i.e. another different set up of a given mode. In such case one or more attributes—stored or represented in the printed barcode, printed pattern, the smart card, the magnet stripe, the transponder, and/or the code tag, etc., as a part of gear and apparel—has to be changed accordingly. This may be performed in a direct way by a new barcode, a new pattern, a new content of the smart card, a new magnet stripe, as a part of gear and apparel—and/or—by redefining meaning of attributes and corresponding modes on the mobile device.

Alternatively—by means of identification writers (discussed in FIG. 1)—this may be performed in an indirect way by downloading or programming one or more attributes to the smart card, the transponder, the code tag, etc.

Throughout the application—when the wording “presentation”, “present” or the like is used—it is intended to designate that information content may be displayed on a corresponding display of the mobile device. And, further—in case that information content is suitable for being emitted through a loudspeaker, i.e. when said content comprises sounds and/or music—content is also played back. This is possible since said mobile device may comprise a loudspeaker or a like device.

By the wording “information content” or “information item”, first and second messages are meant information, which would normally represent what may be presented by means of a display and/or a loudspeaker on the mobile device, i.e. plain text, pictures, frames, video, word-processor data, spread-sheet data, calendar or almanac information, schedule information, text or picture messages, voice mail, video mail, e-mail, SMS and combinations thereof.

In the case that a mode determines a new presentation style, backlight of buttons, backlight of display, colour of characters, text, frames, level and/or type of sound, music, texture, volume and/or kind of ring tone, switching on or of, vibration on or of, etc., may be changed accordingly.

Usually, the method will start all over again for as long as said mobile device is powered. Otherwise, the method may terminate in step 800; however, when the mobile device is powered again, etc, the method may proceed from step 100.

Said mobile device may be a mobile telephone, a personal digital assistant, a palm top, a cell phone or any other mobile device capable of executing said method.

A computer readable medium may be magnetic tape, optical disc, digital versatile disk (DVD), compact disc (CD record-able or CD write-able), mini-disc, hard disk, floppy disk, smart card, PCMCIA card, etc.

In the claims, any reference signs placed between parentheses shall not be constructed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of presenting an information item on a mobile device, said method comprising the steps of:
retrieving an identification of at least one of user gear and apparel;
determining a mode reflecting at least one attribute of identified gear and apparel and optionally sending the mode with an identification of said mobile device to a service provider; and
determining and presenting the information item dependent on said mode.

2. A method according to claim 1 further comprising the steps of:
receiving a first message from a caller sent to said mobile device;
determining a second message dependent on said mode, when said first message is received; and
sending the second message to the caller as a response to said first message.

3. A method according to claim 2 characterized in that the step of determining a second message comprises the steps of:
sending the mode with an identification of said mobile device to a service provider; and
determining the second message based on the received mode and the identification of said mobile device on the service provider.

4. A method according to claim 1 further comprising the step of:
modifying at least one attribute of gear and apparel.

5. A method according to claim 1, characterized in that the mobile device is a personal digital assistant, palm top, cell phone or a mobile phone.

6. A computer program product comprising program code means stored on a computer readable medium for performing the method of any one of claims 1 through 5 when the computer program is run on a computer.

7. A mobile device for presenting an information item, said mobile device comprising:
at least one identification reader for retrieving an identification of at least one of user gear and apparel;
means for determining a mode reflecting at least one attribute of identified gear and apparel and means for optionally sending the mode with an identification of said mobile device to a service provider; and
means for determining and presenting the information item dependent on said mode.

8. A mobile device according to claim 7 further comprising:
means for receiving a first message from a caller;
means for determining a second message dependent on said mode, when said first message is received; and
means for sending the second message to the caller as a response to said first message.

9. A mobile device according to claim 8 characterized in that the means for determining a second message comprises:
means for sending the mode with an identification of said mobile device to a service provider, where said service provider determines the second message.

10. A mobile device according to any one of claims 7 through 9 further comprising:
means for modifying at least one attribute of gear and apparel.
